(19) United States
(12) Patent Application Publication
(10) Pub. No.: US 2026/0273848 A1
(43) Pub. Date: Sep. 17, 2026

(54) METHODS AND SYSTEMS FOR LARGE-SCALE ADDITIVE MANUFACTURING WITH ROBOTIC CONVEYING

(71) Applicants: Christopher B. WILLIAMS, Blacksburg, VA (US); Joseph KUBALAK, State College, PA (US)

(72) Inventors: Christopher B. WILLIAMS, Blacksburg, VA (US); Joseph KUBALAK, State College, PA (US)

(21) Appl. No.: 19/168,216

(22) PCT Filed: Mar. 22, 2024
(86) PCT No.: PCT/US2024/021169

§ 371 Date: Sep. 23, 2025

Related U.S. Application Data
(60) Provisional application No. 63/454,225, filed on Mar. 23, 2023.

(51) Int. Cl. B29C 64/245; B29C 64/209; B29C 64/236; B33Y 10/00; B33Y 30/00

(52) U.S. Cl. CPC B29C 64/245; B29C 64/209; B29C 64/236; B33Y 10/00; B33Y 30/00

(57) ABSTRACT

Embodiments of an additive manufacturing apparatus and method using a variable deposition plane are described. In one example, an additive manufacturing apparatus includes a movement mechanism including a print head configured to extrude a depositing material. The additive manufacturing apparatus further includes a conveyor belt including a deposition surface to support the depositing material from the print head. The additive manufacturing apparatus further includes a controller coupled to the movement mechanism, the print head, and the conveyor belt. The controller is configured to control the conveyor belt to operate in a moving phase when the conveyor belt moves. The controller is further configured to control the movement mechanism and the print head to extrude a layer of the depositing material over the deposition surface based on a variable deposition plane when the conveyor belt is in the moving phase.

### CROSS REFERENCE TO RELATED APPLICATIONS

This application claims the benefit of and priority to U.S. Provisional Application Ser. No. 63/454,225, filed Mar. 23, 2023, titled “METHODS AND SYSTEMS FOR LARGE-SCALE ADDITIVE MANUFACTURING WITH ROBOTIC CONVEYING” the entire contents of which are hereby incorporated herein by reference.

### BACKGROUND

Additive manufacturing technologies enable the fabrication of a variety of parts and designs from a relatively small set of feedstock materials. Using additive manufacturing for large-scale manufacturing offers several benefits over traditional manufacturing techniques. One advantage is the ability to create complex geometries and structures that would be difficult or impossible to produce with traditional techniques. Additionally, additive manufacturing can reduce material waste and manufacturing time, as parts can be produced on demand without the need for tooling.

### SUMMARY

The present disclosure is directed to a novel additive manufacturing apparatus and method for fabricating objects using such an apparatus. The additive manufacturing apparatus can be embodied as an additive manufacturing apparatus with robotic arm and conveying components and functionality. For instance, the additive manufacturing apparatus can include a print head coupled to a robotic arm. The robotic arm can operate within any of six degrees of freedom to cause the print head to extrude material over various locations on a deposition surface of a belt on a conveyor belt while the belt is stationary or moving. In some examples, the additive manufacturing apparatus can cause the print head to extrude multiple layers (e.g., as opposed to only a single layer) of the material over the deposition surface between moving phases of the belt, or while the belt is moving in some cases. In other examples, the additive manufacturing apparatus can cause the print head to extrude the material over the deposition surface in non-planar or curved deposition surfaces (e.g., non-planar or curved slicing surfaces) between moving phases of the belt, or while the belt is moving in some cases.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, an additive manufacturing apparatus includes a movement mechanism including a print head configured to extrude a depositing material. The additive manufacturing apparatus further includes a conveyor belt including a deposition surface to support the depositing material from the print head. The additive manufacturing apparatus further includes a controller coupled to the movement mechanism, the print head, and the conveyor belt. The controller being configured to control the conveyor belt to operate in a moving phase when the conveyor belt moves. The controller being further configured to control the movement mechanism and the print head to extrude a layer of the depositing material over the deposition surface based on a variable deposition plane when the conveyor belt is in the moving phase.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1 illustrates a schematic of an example additive manufacturing apparatus implemented to fabricate an example object according to various aspects and embodiments of the present disclosure.

FIG. 2 illustrates a schematic of the additive manufacturing apparatus of FIG. 1 implemented to fabricate another example object according to various aspects and embodiments of the present disclosure.

FIG. 3 illustrates a schematic of the additive manufacturing apparatus of FIG. 1 implemented to fabricate another example object according to various aspects and embodiments of the present disclosure.

FIG. 4 illustrates an additive manufacturing method according to various aspects and embodiments of the present disclosure.

FIG. 5 illustrates a block diagram of an example computing device according to various aspects and embodiments of the present disclosure.

FIG. 6 illustrates a diagram of an example computer-implemented additive manufacturing method according to various aspects and embodiments of the present disclosure.

FIG. 7 illustrates an example toolpath deformation according to various aspects and embodiments of the present disclosure.

FIG. 8 illustrates a schematic of another example additive manufacturing apparatus implemented to fabricate an object according to various aspects and embodiments of the present disclosure.

FIG. 9 illustrates a schematic of an example build plate according to various aspects and embodiments of the present disclosure.

FIG. 10 illustrates an example segmented object built with differently angled slicing planes according to various aspects and embodiments of the present disclosure.

### DETAILED DESCRIPTION

Large-format additive manufacturing (AM) systems attempt to address the industry's need for fabricating large-scale tooling and large final products. The depositing material used is typically a polymer, metal, or a composite material. However, these large-format AM systems feature a standard 3-axis gantry architecture for moving a print head, restricting the size of an object being built to the size of the gantry architecture. Thus, large factory footprints are needed to build large objects. As a result, these systems are constrained in terms of portability, ease of deployment, and scalability. In addition, the 3-axis gantry architecture restricts the shapes of the objects that can be built without the need for support materials.

In some existing conveyor belt printers, three-degrees-of-freedom (DoF) motion is achieved by attaching a two-DoF gantry (e.g., at a bias) to the conveyor. This allows the tool head to move along “Y” and “Z” orthogonal axes of a three-dimensional space and the conveyor moves a printed object along an “X” orthogonal axis of the three-dimensional space. However, a problem with such a conveyor belt printer is that it is a fully constrained kinematic system. The conveyor of such a printer must index forward for each deposition plane or layer in a toolpath when fabricating an object. An additional limitation is that only a single bias angle of the deposition plane can be used through the entire print process.

The embodiments described herein alleviate the problems associated with existing large-format AM systems. The embodiments provide an additive manufacturing apparatus or system that includes a print head movement mechanism having at least four degrees of freedom, and can include seven degrees of freedom, where one of the degrees of freedom is provided by a conveyor belt over which an object is built. In some examples, the print head movement mechanism can be embodied as a print head coupled to a robotic arm. In other examples, the print head movement mechanism can be embodied as a print head coupled to a gantry system. The relatively high degrees of freedom with which the print head movement mechanism can be manipulated enable the additive manufacturing or building of objects with deposition or slicing planes of variable angles, including curved deposition planes, from part to part and also within the same part. Changing the angle of the deposition or slicing planes can allow building objects with overhang features without the need of support structures. The techniques described herein can also result in finished parts or objects with improved overall structural strength.

The additional degrees of freedom also allow the print head to move in new ways in relation to the conveyor belt. This can alleviate the need for stepping the conveyor belt for each deposition plane or layer, reducing potential inaccuracies associated with the inability to precisely step the conveyor belt forward for large parts. Some embodiments allow the building of an object into chunks, where a movement mechanism can move a print head to deposit multiple layers of a depositing material to build a chunk of the object before the conveyor belt is moved again. That is, instead of moving the conveyor belt after each layer is deposited, the conveyor belt is moved only between printed chunks of the object and each chunk has multiple layers of the depositing material. “Chunk” printing with existing conveyor belt printer systems involves starting and stopping a conveyor belt to advance an object being built after each layer of material is deposited. Chunk printing may be suitable for small, serialized prints but it is susceptible to slack pick up for large prints. In contrast, the embodiments herein include a movement mechanism having a robotic arm that can “keep up” with a belt moving on a conveyor belt. The ability of the movement mechanism included in embodiments herein to move a print head over multiple layers of deposition precisely and accurately can be far greater than that of the conveyor belt. As a result, large-scale objects can be formed with high accuracy and precision using the embodiments described herein.

In some instances, the moving mechanism can enable using multiple tools through the inclusion of automated tool changers. This can allow embedding secondary objects within an object being built, depositing secondary materials, and machining the object surface. In some examples, more than one movement mechanism can be positioned in relation to a single conveyor belt to allow additional flexibility in working on the object while the object advances on the conveyor belt. Also, the embodiments described herein can accommodate various deposition materials such as, for example, polymer composite melt extrusion, extrusion of soft gels, pastes, and thermosets, and directed energy deposition (e.g., additive friction stir, arc welding, laser powder melting, etc.).

Using a robotic arm to hold a print head as described in various embodiments herein offers a number of advantages. For instance, the robotic arm can vary and change the bias angle throughout an object. The bias angles can be selected during toolpath planning to improve printing or end-use performance (e.g., to reduce support structure usage or align material deposition with anticipated load paths). Even further, the robotic arm allows for curved articulation such that curved deposition surfaces (e.g., as opposed to flat planes) could be used to decompose the geometry into toolpaths. These non-planar or curved deposition surfaces offer even more flexibility in how a toolpath can be printed, and this is only possible with a high-DoF system like the robotic arm of embodiments herein.

Additionally, the conveyor belt does not need to index every layer in some control approaches. The kinematic redundancy offered by the robotic arm of the embodiments means that both the robotic arm and conveyor belt can move in the same direction. In some embodiments, an object could be decomposed into chunks (e.g., each with a single or multiple bias angles) such that the conveyor belt stays static for contiguous portions of the fabrication process. In other embodiments, the conveyor belt could index for each layer, as is done with existing conveyor belt printers or other gantry systems. In still other embodiments, the conveyor belt could move continuously for one or more portions of the toolpath or for the entire toolpath. Due to slack pickup caused by gear dynamics in many conveyor belts, these motion concepts offer improved print accuracies.

Moving the conveyor belt continuously as described herein requires advances in toolpath planning, as conventional slicing and printing paradigms rely on a static part relative to the deposition system. As such, after toolpath planning (e.g., slicing) is completed in various embodiments herein, a toolpath (e.g., GCode) can be deformed along an axis in which the conveyor belt moves based on a selected conveyor belt speed. This allows the robotic arm of these embodiments to track the motion of an object being built as the conveyor belt moves.

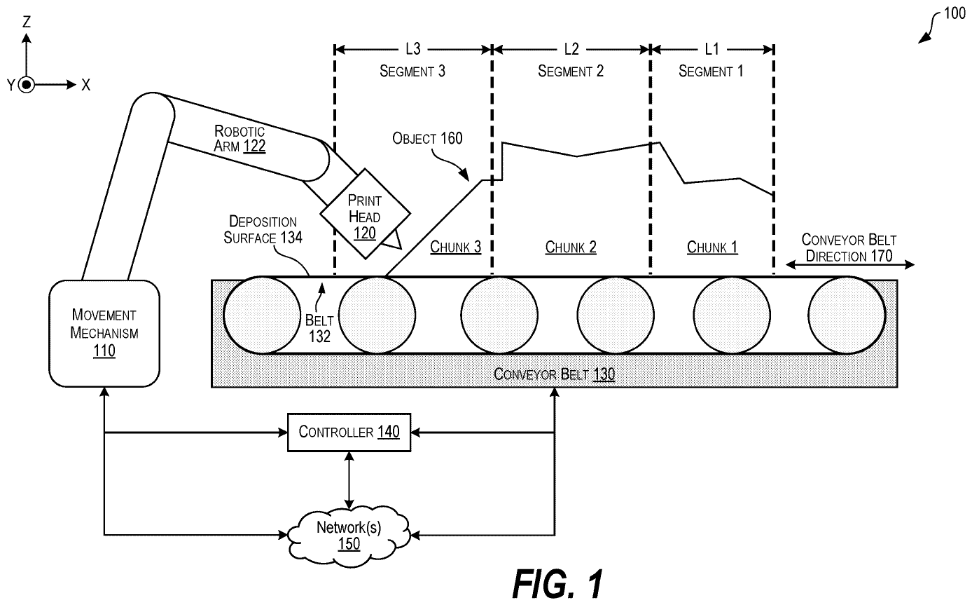

For context, FIG. 1 illustrates a schematic of an example additive manufacturing apparatus 100 according to various aspects and embodiments of the present disclosure. The additive manufacturing apparatus 100 includes a movement mechanism 110 (also referred to herein as “print head movement mechanism”), a conveyor belt 130, and a controller 140 in the example shown. The movement mechanism 110 in this example includes a print head 120 coupled to a robotic arm 122. The conveyor belt 130 in this example includes a belt 132 having a deposition surface 134 upon which a depositing material can be deposited by the print head 120 to build an object 160. When the conveyor belt 130 is in a moving phase, the belt 132 moves in a conveyor belt direction 170 along an axis “X” depicted in FIG. 1.

In some examples, the movement mechanism 110, the conveyor belt 130, and the controller 140 of the additive manufacturing apparatus 100 can be designed and embodied together as a single unit or system. In other examples, one or more of the movement mechanism 110, the conveyor belt 130, and the controller 140, or a component thereof, can be designed and embodied as a discrete subunit or subsystem that can be physically separated from and/or external to the additive manufacturing apparatus 100. In some cases, the additive manufacturing apparatus 100 can include additional components, fewer components, or alternative components compared to those illustrated in FIG. 1. In one example, the additive manufacturing apparatus 100 can include multiple movement mechanisms 110 that each have a print head 120 coupled to a robotic arm 122.

In the example shown, the print head 120 and the robotic arm 122 are each coupled (e.g., electrically, mechanically, operatively, communicatively) to the movement mechanism 110. The controller 140 is also coupled to the movement mechanism 110 and the conveyor belt 130. The controller 140 may be coupled to the movement mechanism 110 and the conveyor belt 130 by way of one or more networks 150 (or “network 150”). The network 150 can include local interfaces, local busses, the Internet, intranets, extranets, wide area networks (WANs), local area networks (LANs), wired networks, wireless networks (e.g., cellular, WiFi®), cable networks, satellite networks, other suitable networks, or any combinations thereof.

The movement mechanism 110, the conveyor belt 130, and the controller 140 can communicate data with one another over the network 150 using any suitable systems interconnect models and/or protocols. Example interconnect models and protocols include local serial or parallel bus interface protocols, hypertext transfer protocol (HTTP), simple object access protocol (SOAP), representational state transfer (REST), real-time transport protocol (RTP), real-time streaming protocol (RTSP), real-time messaging protocol (RTMP), user datagram protocol (UDP), internet protocol (IP), transmission control protocol (TCP), and/or other protocols for communicating data over the network 150, without limitation. Although not illustrated, the networks 150 can also include connections to any number of network hosts, such as website servers, file servers, networked computing resources, databases, data stores, or other network or computing architectures in some cases.

The additive manufacturing apparatus 100 can be utilized to manufacture large-scale components. In the example shown, the additive manufacturing apparatus 100 is being utilized to manufacture the object 160 on the deposition surface 134 (also referred to herein as a “build surface”) of the conveyor belt 130. In some cases, the additive manufacturing apparatus 100 can be implemented to manufacture the object 160 as a single unit or in sections (also referred to herein as “chunks”) that correspond to respective segments of the deposition surface 134. In the example shown, the additive manufacturing apparatus 100 can be implemented to manufacture a first portion of the object 160 as “Chunk 1” (or “C1”), a second portion of the object 160 as “Chunk 2” (or “C2”), and a third portion of the object 160 as “Chunk 3” (or “C3”), although the object 160 may have more or less chunks in some cases. The chunks C1, C2, C3 respectively correspond to a “Segment 1” (or “S1”), a “Segment 2” (or “S2”), and a “Segment 3” (or “S3”) of the deposition surface 134, although the deposition surface 134 may have more or less segments in some cases. In this example, the segment S1 has a length of “L1,” the segment S2 has a length of “L2,” and the segment S3 has a length of “L3.” In some examples, each of the segments S1, S2, S3 has the same length. In other examples, at least one of the segments S1, S2, S3 has a length that is different compared to other segments.

The movement mechanism 110 can have at least four degrees of freedom based on the design of the robotic arm 122, the movement mechanism 110, or a combination of the robotic arm 122 and the movement mechanism 110. In some instances, the movement mechanism 110 can have six degrees of freedom, allowing the additive manufacturing apparatus 100 to have seven degrees of freedom when combined with movement in the conveyor belt direction 170 (e.g., movement in either direction along an axis “X” illustrated in FIG. 1). Degrees of freedom can refer to mechanical degrees of freedom of movement of a system of linked rigid bodies in three-dimensional space. For example, six degrees of freedom that can be achieved by the movement mechanism 110 can include a change of position as forward or backward movement, up or down movement, or left or right movement along orthogonal axes in a three-dimensional (3D) space, combined with changes in orientation through yaw, pitch, and roll about such orthogonal axes. In the example shown, the movement mechanism 110 includes the robotic arm 122 having at least four degrees of freedom (e.g., six degrees of freedom). In some instances, the movement mechanism 110 can be designed, embodied, and implemented as a gantry system having at least four degrees of freedom.

The controller 140 can control the movement of the movement mechanism 110 to position the print head 120 at various desired locations over the deposition surface 134 on the belt 132. For example, the controller 140 can control the movement of the robotic arm 122 of the movement mechanism 110 to position the print head 120 at a desired position in a three-dimensional (3D) space defined by orthogonal axes “X,” “Y,” and “Z” (or “axes X, Y, Z”) depicted in FIG. 1. For instance, the controller 140 can control the robotic arm 122 along any or all of the axes X, Y, Z to position the print head 120 at a desired location over one or more segments S1, S2, S3 of the deposition surface 134 on the belt 132 of the conveyor belt 130. Additionally, the controller 140 can control the robotic arm 122 about any or all of the axes X. Y, Z to execute roll, pitch, and yaw movements (e.g., rotations) about such axes when positioning the print head 120 at such a desired location over the segments S1, S2, S3 of the deposition surface 134 on the belt 132 of the conveyor belt 130. The print head 120 (also known as an “extruder”) can controllably extrude a depositing material on a surface to form one or more layers. For instance, the controller 140 can read a digital file that defines a shape and size of the object 160 to be built and can then divide the object 160 into multiple slicing planes or layers as described in examples herein. The controller 140 can then control the print head 120 to extrude the depositing material layer by layer to form the final object 160. In various examples, the print head 120 can be designed, embodied, and implemented as a three-dimensional or additive manufacturing printing head or extruder that can be configured to extrude a depositing material.

In the example shown, the belt 132 of the conveyor belt 130 includes the deposition surface 134 over which the print head 120 can deposit the depositing material. In this example, the belt 132 of the conveyor belt 130 carries the object 160 in the conveyor belt direction 170 as it is being built, the conveyor belt direction 170 being represented by an arrow in FIG. 1. The direction of movement of the belt 132 in the conveyor belt direction 170 can move the object 160 away from the movement mechanism 110, for example, away from the print head 120 and the robotic arm 122 as the object 160 is being built. The conveyor belt 130 can include a motor (not illustrated) that moves the belt 132 and can be controlled by the controller 140. The controller 140 can control the motor to start or stop the belt 132 and control the magnitude (e.g., speed, acceleration) of motion of the belt 132. In some instances, the conveyor belt 130 can include a gearbox (not illustrated) that can be controlled by the controller 140 to control the speed or acceleration of the belt 132.

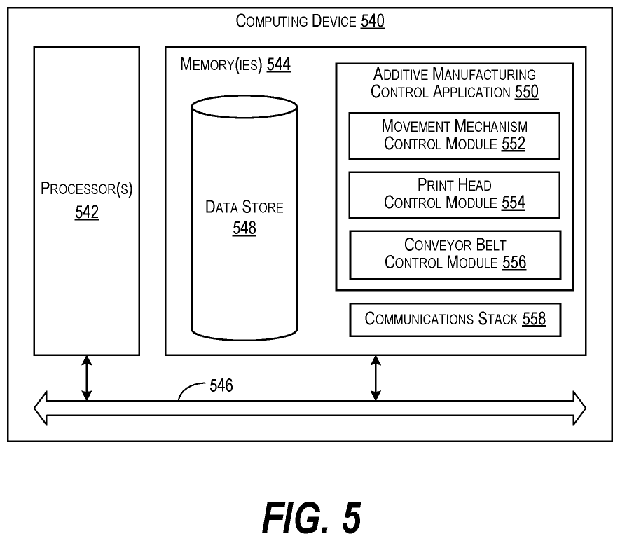

The controller 140 can include one or more programmable microcontrollers, microprocessors, program logic controllers, field programmable gate arrays, or other controller devices that can be programmed to carry out various operations of the additive manufacturing apparatus 100 described herein. The controller 140 can include volatile and non-volatile memory and interface circuitry for communication with other components of the additive manufacturing apparatus 100 such as the movement mechanism 110 and the conveyor belt 130. The controller 140 can also include peripheral interface circuitry for communicating with peripherals such as user input/output devices. In some instances, the controller 140 can be executed on a personal computer, a laptop, a tablet, a cell phone, or other mobile or non-mobile computers. In various examples of the present disclosure, the controller 140 can be designed, embodied, and implemented at least in part as a computing device 540 described herein and illustrated in FIG. 5. In these examples, the controller 140 can include the same hardware and software components, architecture, and functionality as that of the computing device 540. The controller 140 can execute a program or instructions that allow the controller 140 to read a digital file that describes the object 160 to be built and then transform the description into instructions for controlling the movement mechanism 110 and the conveyor belt 130. The controller 140 can control the conveyor belt 130 to operate between stationary phases when the belt 132 is stationary and moving phases when the belt 132 is moving. These and other examples are described below.

In one example stationary phase, the controller 140 can control the conveyor belt 130 to cause the belt 132 to be stationary (e.g., no movement). In another example stationary phase, the controller 140 can control the movement mechanism 110 (e.g., the robotic arm 122 and the print head 120) such that the print head 120 can extrude one or more layers (e.g., two or more layers) of a depositing material over the deposition surface 134 of the belt 132 on the conveyor belt 130. In another example stationary phase, the controller 140 can control the movement mechanism 110 to deposit at least one first layer of a depositing material in a first segment of the deposition surface 134 such as, for instance, segment S3 depicted in FIG. 1. In this same stationary phase, the controller 140 can then control the movement mechanism 110 to deposit at least one second layer of the depositing material in a second segment of the deposition surface 134 such as, for instance, segment S2 depicted in FIG. 1.

In one example moving phase, the controller 140 can control the conveyor belt 130 to move the belt 132 and the deposition surface 134 in one of two directions (e.g., forward or backwards) along axis X depicted in FIG. 1. In the example shown, the controller 140 can control the conveyor belt 130 to move the belt 132 and the deposition surface 134 in a first direction, for instance, in the conveyor belt direction 170. In this example, the controller 140 can also control the conveyor belt 130 to move the belt 132 and the deposition surface 134 in a second direction that is opposite to the conveyor belt direction 170 along axis X depicted in FIG. 1. In another example moving phase, the controller 140 can control the conveyor belt 130 to move the belt 132 a predetermined distance, for example, a distance that is equal to any of the lengths L1, L2, L3 of the segments S1, S2, S3 or another distance in some cases. In another example moving phase, the controller 140 can control the conveyor belt 130 to move the belt 132 periodically (e.g., incrementally or in steps between deposits of depositing material) or continuously (e.g., at a constant or varying speed or acceleration while depositing material is being deposited).

Existing additive manufacturing systems that include conveyor belts extrude a single layer of a depositing material from a print head, then move a conveyor belt by an incremental distance, and deposit another single layer of the depositing material. By repeating the single layer depositions interspaced by incremental movement of the conveyor belt, the traditional systems can build the object layer by layer. The range of motion of the print head of such existing additive manufacturing systems is limited to within a single plane that is positioned at a fixed angle with respect to a build or deposition plane surface on or over the conveyor belt. This limits the number of layers that the print head can deposit before the conveyor belt has to be moved incrementally to one layer per incremental movement of the conveyor belt. In addition, the deposited layer is deposited in a planar manner, being limited to the single plane in which the print head can move by the movement mechanism.

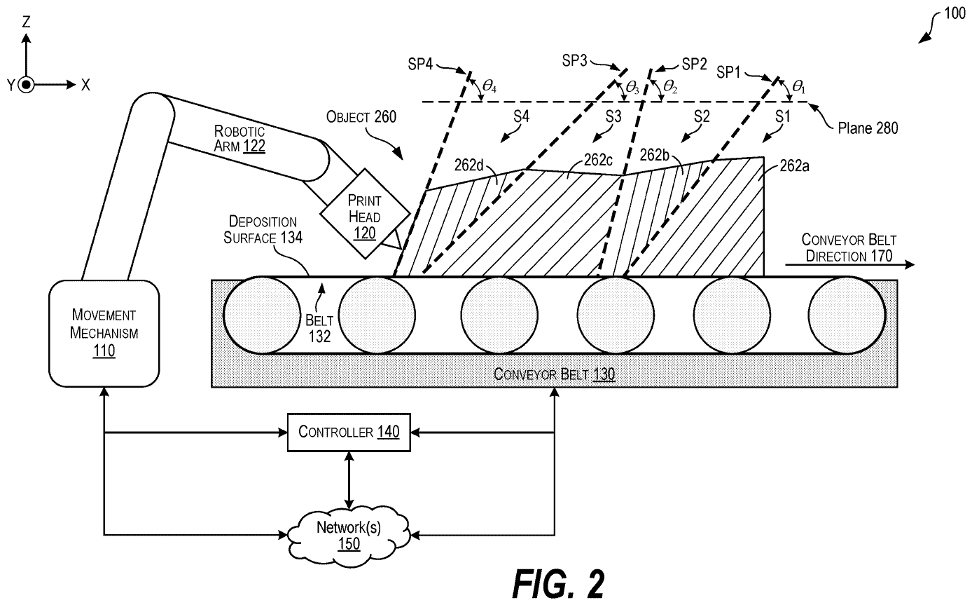

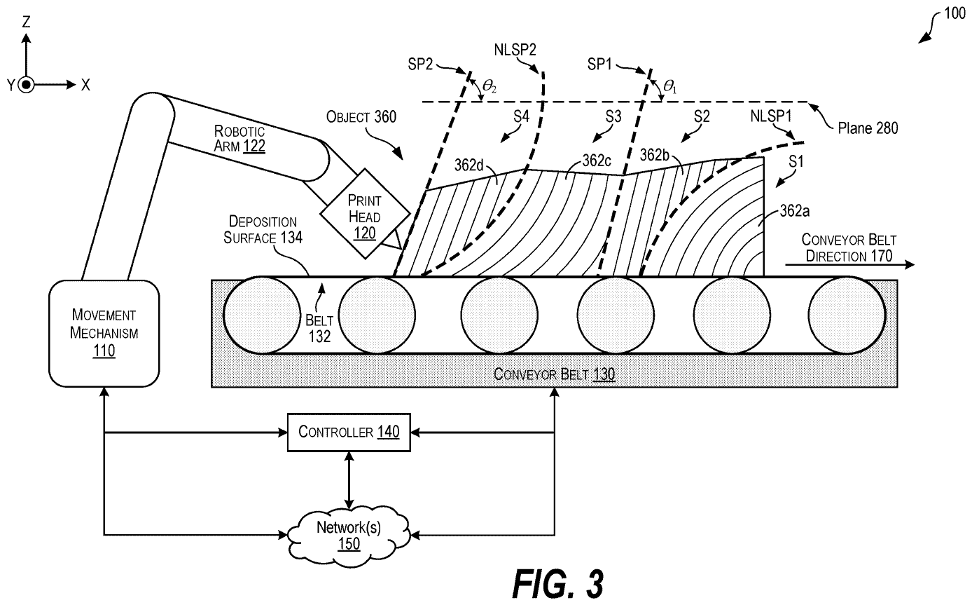

The additive manufacturing apparatus 100 on the other hand includes the movement mechanism 110. The movement mechanism 110 allows positioning of the print head 120 anywhere along the deposition surface 134 that is within the reach of the robotic arm 122 when the conveyor belt 130 is in a stationary or moving phase. As a result, the controller 140 can control the movement mechanism 110 (e.g., the print head 120 and the robotic arm 122) to deposit any number of planar and/or non-planar layers of depositing material in different segments on or over the deposition surface 134 while the belt 132 is stationary or moving to fabricate a variety of different objects. The planar and non-planar (e.g., curved-surface) layers of material being deposited by the print head 120 are also referred to herein as a slicing or deposition planes or surfaces. Examples of such planar and non-planar layers that can be formed by the additive manufacturing apparatus 100 are illustrated in FIGS. 2 and 3.

FIG. 2 illustrates a schematic of the additive manufacturing apparatus 100 implemented to fabricate another example object 260. To fabricate the object 260 illustrated in FIG. 2, the controller 140 can control the movement mechanism 110 to respectively deposit multiple layers 262a, 262b, 262c, 262d of a depositing material across segments S1, S2, S3, S4 of the deposition surface 134 while the belt 132 is in at least one stationary phase or a moving phase over time. Only a single layer 262a, 262b, 262c, 262d of depositing material is denoted in FIG. 2 for clarity purposes.

The controller 140 can control the movement mechanism 110 (e.g., the print head 120 and the robotic arm 122) to deposit one or more layers 262a of depositing material over segment S1 in a first slicing or deposition plane “SP1,” one or more layers 262b of depositing material over segment S2 in a second slicing or deposition plane “SP2,” one or more layers 262c of depositing material over segment S3 in a third slicing or deposition plane “SP3,” and one or more layers 262d of depositing material over segment S4 in a fourth slicing or deposition plane “SP4.” In this example, the first slicing plane SP1 can be positioned or oriented at a first angle θ₁ relative to a plane 280 that is parallel to the deposition surface 134. Additionally, the second slicing plane SP2 can be positioned or oriented at a second angle θ₂ relative to the plane 280, the third slicing plane SP3 can be positioned or oriented at a third angle θ₃ relative to the plane 280, and the fourth slicing plane SP4 can be positioned or oriented at a fourth angle θ₄ relative to the plane 280. In the example shown, each of the first, second, third, and fourth angles θ₁, θ₂, θ₃, θ₄ is different from the other angles. In some examples, each of the first, second, third, and fourth angles θ₁, θ₂, θ₃, θ₄ can be the same angle. In other examples at least one of the first, second, third, and fourth angles θ₁, θ₂, θ₃, θ₄ can be different from the other angles.

In one example, the controller 140 can control the movement mechanism 110 to deposit a first layer 262a of depositing material over segment S1 in the first linear slicing plane SP1 such that the first layer 262a of depositing material is formed at the first angle θ₁ relative to the deposition surface 134. The controller 140 can then control the movement mechanism 110 to deposit a second layer 262a of depositing material over segment S1 in the first linear slicing plane SP1 such that the second layer 262a of depositing material is formed on the first layer 262a of depositing material at the first angle θ₁ relative to the deposition surface 134 as illustrated in FIG. 2. In one example, the controller 140 can control the movement mechanism 110 to deposit such first and second layers 262a of depositing material over segment S1 during a single stationary phase when the belt 132 remains stationary between the deposition of the first and second layers 262a of depositing material. In another example, the controller 140 can control the movement mechanism 110 to deposit such first and second layers 262a of depositing material over segment S1 during a moving phase when the belt 132 is moving while the first and second layers 262a of depositing material are being deposited.

In another example, the controller 140 can control the movement mechanism 110 to deposit a layer 262a of depositing material over segment S1 in the first linear slicing plane SP1 such that the layer 262a of depositing material is formed at the first angle θ₁ relative to the deposition surface 134. In this example, the controller 140 can then control the movement mechanism 110 to deposit a layer 262b of depositing material over segment S2 in the second linear slicing plane SP2 such that the layer 262b of depositing material is formed on the layer 262a of depositing material at the second angle θ₂ relative to the deposition surface 134 as illustrated in FIG. 2. In one example, the controller 140 can control the movement mechanism 110 to respectively deposit such layers 262a, 262b of depositing material over segments S1, S2 during a single stationary phase when the belt 132 remains stationary between the deposition of the layer 262a and the layer 262b of depositing material. In another example, the controller 140 can control the movement mechanism 110 to respectively deposit such layers 262a, 262b of depositing material over segments S1, S2 during a moving phase when the belt 132 is moving while the layers 262a, 262b of depositing material are being deposited.

FIG. 3 illustrates a schematic of the additive manufacturing apparatus 100 implemented to fabricate another example object 360 according to various aspects and embodiments of the present disclosure. To fabricate the object 360 illustrated in FIG. 3, the controller 140 can control the movement mechanism 110 to respectively deposit multiple layers 362a, 362b, 362c, 362d of a depositing material across segments S1, S2, S3, S4 of the deposition surface 134 while the belt 132 is in at least one stationary phase or a moving phase. Only a single layer 362a, 362b, 362c, 362d of depositing material is denoted in FIG. 3 for clarity purposes. In the example shown, each of the layers 362a, 362c are formed as non-planar or curved layers (e.g., non-linear or curved slicing or deposition surfaces) and each of the layers 362b, 362d are formed as planar layers (e.g., linear slicing or deposition planes). In this example, the controller 140 can be configured to control the movement mechanism 110 to move the print head 120 in a non-planar (e.g., non-linear or curved) manner while the print head 120 is extruding the depositing material forming each of the layers 362a, 362c and to move the print head 120 in a planar (e.g., linear) manner while the print head 120 is extruding the depositing material forming each of the layers 362b, 362d.

In one example, the controller 140 can control the movement mechanism 110 to deposit one or more layers 362a of depositing material over segment S1 in a first non-linear slicing or deposition plane “NLSP1,” one or more layers 362b of depositing material over segment S2 in a first linear slicing or deposition plane “SP1,” one or more layers 362c of depositing material over segment S3 in a second non-linear slicing or deposition plane “NLSP2,” and one or more layers 362d of depositing material over segment S4 in a second. linear slicing or deposition plane “SP2.” The first and second non-linear slicing planes NLSP1, NLSP2 can each be defined by a certain curve function or formula. In the example shown, the first and second non-linear slicing planes NLSP1, NLSP2 are each defined by a different curve function or formula. In other examples, the first and second non-linear slicing planes NLSP1, NLSP2 can each be defined by the same curve function or formula. The first linear slicing plane SP1 can be positioned or oriented at a first angle θ₁ relative to the plane 280 and the second linear slicing plane SP2 can be positioned or oriented at a second angle θ₂ relative to the plane 280. In the example shown, the first and second angles θ₁, θ₂ are different from one another. In other examples, each of the first and second angles θ₁, θ₂ can be the same angle.

In one example, the controller 140 can control the movement mechanism 110 to deposit a first layer 362a of depositing material over segment S1 in the first non-linear slicing plane NLSP1 such that the first layer 362a of depositing material is formed as a first curved or non-planar layer. In this example, the controller 140 can then control the movement mechanism 110 to deposit a second layer 362a of depositing material over segment S1 in the first non-linear slicing plane NLSP1 such that the second layer 362a of depositing material is formed on the first layer 362a as a second curved or non-planar layer. In one example, the controller 140 can control the movement mechanism 110 to deposit each of such first and second layers 362a of depositing material over segment S1 in a non-linear manner during a single stationary phase when the belt 132 remains stationary between the deposition of the first and second layers 362a of depositing material. In another example, the controller 140 can control the movement mechanism 110 to deposit each of such first and second layers 362a of depositing material over segment S1 in a non-linear manner during a moving phase when the belt 132 is moving while the first and second layers 362a of depositing material are being deposited.

In another example, the controller 140 can control the movement mechanism 110 to deposit a layer 362a of depositing material over segment S1 in the first non-linear slicing plane NLSP1 such that the layer 362a of depositing material is formed as a curved or non-planar layer. In this example, the controller 140 can then control the movement mechanism 110 to deposit a layer 362b of depositing material over segment S2 in the first linear slicing plane SP1 such that the layer 362b of depositing material is formed on the layer 362a of depositing material at the first angle θ₁ relative to the deposition surface 134 as illustrated in FIG. 3. In one example, the controller 140 can control the movement mechanism 110 to respectively deposit such layers 362a, 362b of depositing material over segments S1, S2 in a non-linear manner during a single stationary phase when the belt 132 remains stationary between the deposition of the layer 362a and the layer 362b of depositing material. In another example, the controller 140 can control the movement mechanism 110 to respectively deposit such layers 362a, 362b of depositing material over segments S1, S2 in a non-linear manner during a moving phase when the belt 132 is moving while the layers 362a, 362b of depositing material are being deposited.

FIG. 3 shows a depiction of the robotic arm based additive manufacturing apparatus 100 where at least one slicing plane is non-planar. The ability of the movement mechanism 110 to move the print head 120 along the length of the conveyor belt 130 (e.g., along axis X depicted in FIG. 3), allows the print head 120 to deposit the depositing material in a non-planar slicing plane such as, for instance, the first or second non-linear slicing planes NLSP1, NLSP2. A slicing plane can correspond to a plane in which the print head extrudes one layer of the depositing material. A slicing plane of the robotic arm based additive manufacturing apparatus 100 can have a curvature as opposed to the planar slicing planes of traditional additive manufacturing systems. Such a non-planar slicing plane can allow the robotic arm based additive manufacturing apparatus 100 to build more complex objects with high structural strength, improve surface finish, and in some cases alleviate the need for support structures to build complex shaped objects.

It should be noted that non-planar slicing planes described in examples herein (e.g., the first and second non-linear slicing planes NLSP1, NLSP2) can be formed even without the use of the robotic arm 122, for example, gantry-based systems can also be used to form such non-planar slicing planes. It should also be noted that the robotic arm based additive manufacturing apparatus 100 can extrude the depositing material in a planar manner as well.

In some examples, the controller 140 can control the movement mechanism 110 during a stationary phase of the conveyor belt 130 to move the print head 120 to deposit a depositing material in a first slicing plane (e.g., the first non-linear slicing plane NLSP1) for a first duration and then move the print head 120 to deposit the depositing material in a second slicing plane (e.g., the first linear slicing plane SP1) for a second duration. For example, with reference to FIG. 1, each of the three chunks C1, C2, C3 is positioned at a different location on the deposition surface 134 of the belt 132. In this example, the controller 140 can control the movement mechanism 110 and the print head 120 for a first duration to deposit a depositing material on chunk C1 of the object 160 where the print head 120 can deposit a first slicing plane of the depositing material. The controller 140 can then control the movement mechanism 110 to move the print head 120 over chunk C2 and control the print head 120 to deposit a second slicing plane of depositing material over chunk C2. In this example, the controller 140 can control the movement mechanism 110 and the print head 120 to deposit different slicing planes at different locations on the conveyor belt 130. In some examples, chunks C1, C2, C3 can refer to different portions of the same object 160. In these examples, the controller 140 can control the movement mechanism 110 and the print head 120 to deposit the depositing material in different slicing planes at different locations of the same object 160.

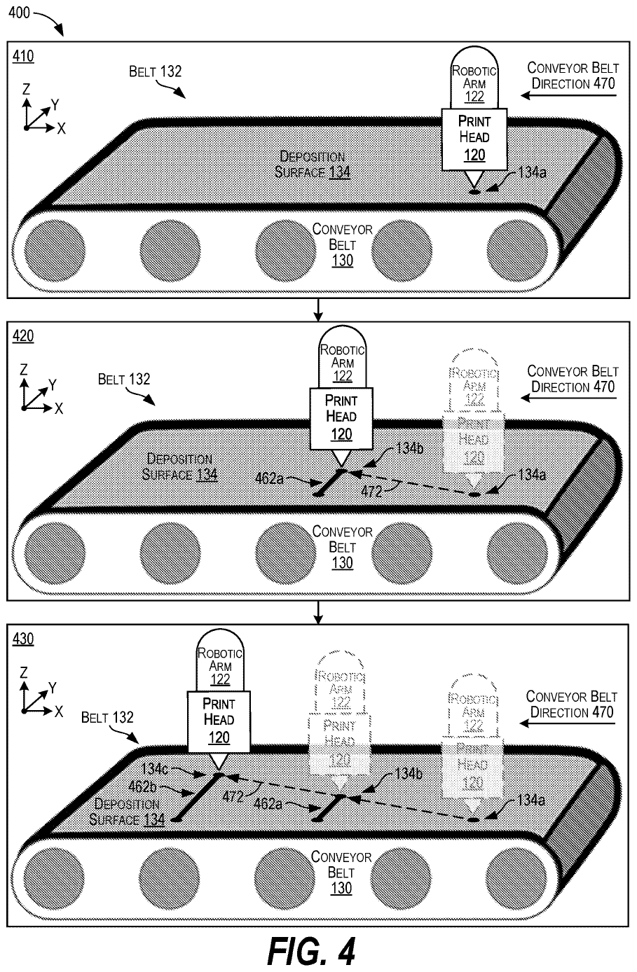

FIG. 4 illustrates an additive manufacturing method 400 (or “AM method 400”) according to various aspects and embodiments of the present disclosure. The AM method 400 can be implemented by the additive manufacturing apparatus 100 to fabricate any of the objects or components thereof described in examples herein while the belt 132 is in a moving phase.

At 410 of the AM method 400, the controller 140 can control the conveyor belt 130 to move the belt 132 in a conveyor belt direction 470 as illustrated in FIG. 4. For instance, the controller 140 can control the conveyor belt 130 to move the belt 132 at a defined speed (e.g., a desired constant speed) along an axis “X” depicted in FIG. 4. At 410 of the AM method 400, the controller 140 can also control the movement mechanism 110 (e.g., the print head 120 and the robotic arm 122) to begin extruding a depositing material at a point 134a located on the deposition surface 134 while the belt 132 is moving.

At 420 of the AM method 400, the controller 140 can continue controlling the conveyor belt 130 to move the belt 132 in the conveyor belt direction 470 at the aforementioned defined speed. At 420 of the AM method 400, the controller 140 can also continue controlling the movement mechanism 110 (e.g., the print head 120 and the robotic arm 122) to move the print head 120 in a print head direction 472 as illustrated in FIG. 4 while the print head 120 is extruding the depositing material on the deposition surface 134 and while the belt 132 is moving in the conveyor belt direction 470 at the defined speed. For instance, the controller 140 can control the movement mechanism 110 to move the print head 120 along at least one of an axis “Y” or “X” depicted in FIG. 4 while the print head 120 is extruding the depositing material on the deposition surface 134 and while the belt 132 is moving in the conveyor belt direction. 470 at the defined speed. For example, the controller 140 can control the movement mechanism 110 to move the print head 120 along axes Y and X from the point 134a to a point 134b located on the deposition surface 134 while the print head 120 is extruding the depositing material on the deposition surface 134 and while the belt 132 is moving in the conveyor belt direction 470 at the defined speed. Based on controlling the movement mechanism 110 to move the print head 120 from the point 134a to the point 134b while the print head 120 is extruding the depositing material on the deposition surface 134 and while the belt 132 is moving in the conveyor belt direction 470 at the defined speed the additive manufacturing apparatus 100 can thereby form a first portion 462a of a layer of depositing material on the deposition surface 134 as illustrated in FIG. 4.

At 430 of the AM method 400, the controller 140 can continue controlling the conveyor belt 130 to move the belt 132 in the conveyor belt direction 470 at the aforementioned defined speed. At 430 of the AM method 400, the controller 140 can also continue controlling the movement mechanism 110 (e.g., the print head 120 and the robotic arm 122) to move the print head 120 in the print head direction 472 as illustrated in FIG. 4 while the print head 120 is extruding the depositing material on the deposition surface 134 and while the belt 132 is moving in the conveyor belt direction 470 at the defined speed. For instance, the controller 140 can control the movement mechanism 110 to move the print head 120 along axes Y and X from the point 134b to a point 134c located on the deposition surface 134 while the print head 120 is extruding the depositing material on the deposition surface 134 and while the belt 132 is moving in the conveyor belt direction 470 at the defined speed. Based on controlling the movement mechanism 110 to move the print head 120 from the point 134b to the point 134c while the print head 120 is extruding the depositing material on the deposition surface 134 and while the belt 132 is moving in the conveyor belt direction 470 at the defined speed the additive manufacturing apparatus 100 can thereby form a second portion 462b of a layer of depositing material on the deposition surface 134 as illustrated in FIG. 4. The second portion 462b of a layer of depositing material includes the first portion 462a of a layer of depositing material in the example shown. In some examples, the second portion 462b of a layer of depositing material depicted in FIG. 4 can be a portion of any layer of deposited material described in embodiments herein such as, for instance, any of the layers 262a, 262b, 262c, 262d or any of the layers 362a, 362b, 362c, 362d.

FIG. 5 illustrates a block diagram of an example computing device 540 according to various aspects and embodiments of the present disclosure. In various examples described herein, the computing device 540 can be used, at least in part, to embody or implement the controller 140. The computing device 540 can include at least one processing system, for example, having at least one processor 542 and at least one memory 544, both of which can be coupled (e.g., communicatively, electrically, operatively) to a local interface 546. The memory 544 can include a data store 548, an additive manufacturing control application 550, a movement mechanism control module 552, a print head control module 554, a conveyor belt control module 556, and a communications stack 558 in the example shown. The computing device 540 can also include other components that are not illustrated in FIG. 5. In some cases, the computing device 540 may not include all the components illustrated in FIG. 5.

The processor 542 can include any processing device (e.g., a processor core, a microprocessor, an application specific integrated circuit (ASIC), a field-programmable gate array (FPGA), a controller, a microcontroller, or a quantum processor) and can include one or multiple processors that can be operatively connected. In some examples, the processor 542 can include one or more complex instruction set computing (CISC) microprocessors, one or more reduced instruction set computing (RISC) microprocessors, one or more very long instruction word (VLIW) microprocessors, or one or more processors that are configured to implement other instruction sets.

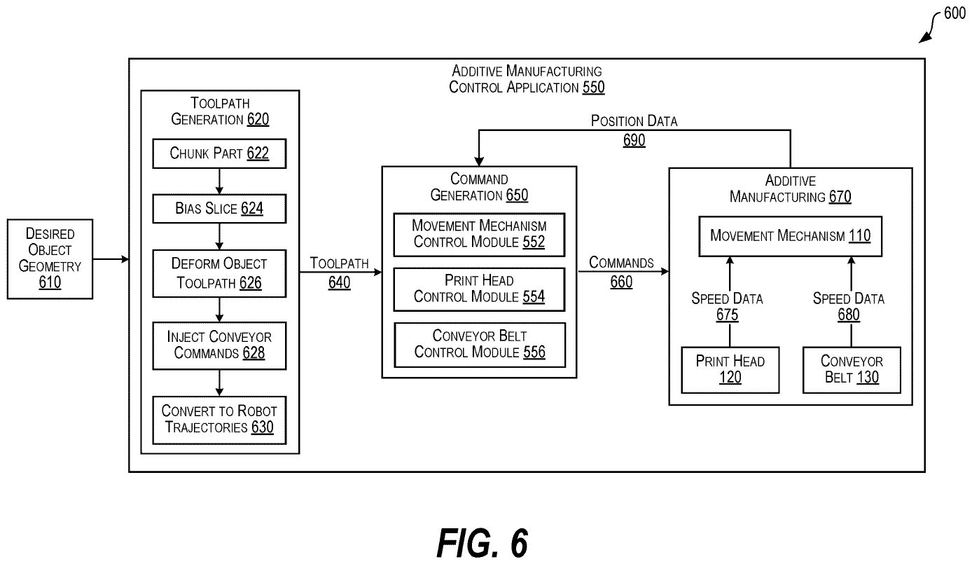

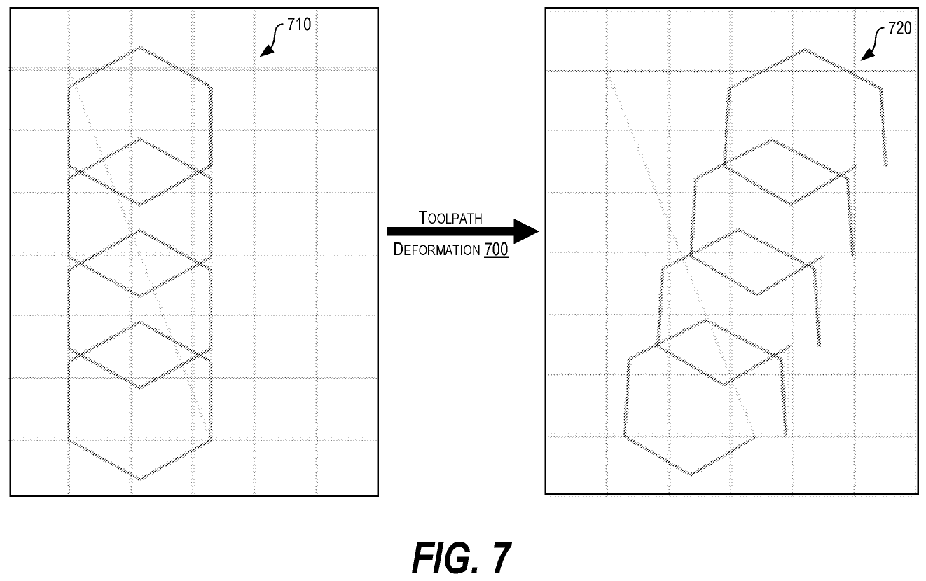

The memory 544 can be embodied as one or more memory devices and store data and software or executable-code components executable by the processor 542. For example, the memory 544 can store executable-code components associated with the additive manufacturing control application 550, the movement mechanism control module 552, the print head control module 554, the conveyor belt control module 556, and the communications stack 558 for execution by the processor 542. The memory 544 can also store data such as the data described below that can be stored in the data store 548, among other data. For instance, the memory 544 can also store at least one of original toolpaths (e.g., “Geometry Code” or “GCode” instructions for fabricating one or more objects using the additive manufacturing apparatus 100 as described in examples herein) or modified toolpaths (e.g., original toolpaths that have been modified to account for a desired or selected speed of the belt 132 as described herein with reference to FIGS. 6 and 7). In another example, the memory 544 can also store various specification and operation data or information for any or all of the movement mechanism 110, the print head 120, the robotic arm 122, the conveyor belt 130, or the belt 132, among possible other components of the additive manufacturing apparatus 100. For instance, the memory 544 can store at least one of predefined commands for operating such components (e.g., default robot trajectories, default material extrusion flow rates, default conveyor belt speeds) or modified commands (e.g., predefined commands that have been modified based on modified toolpaths to account for a desired or selected speed of the belt 132 as described herein with reference to FIGS. 6 and 7).

The memory 544 can store other executable-code components for execution by the processor 542. For example, an operating system can be stored in the memory 544 for execution by the processor 542. Where any component discussed herein is implemented in the form of software, any one of a number of programming languages can be employed such as, for example, C, C++, C#, Objective C, JAVA®, JAVASCRIPT®, Perl, PHP, VISUAL BASIC®, PYTHON®, RUBY, FLASH®, or other programming languages.

As discussed above, the memory 544 can store software for execution by the processor 542. In this respect, the terms “executable” or “for execution” refer to software forms that can ultimately be run or executed by the processor 542, whether in source, object, machine, or other form. Examples of executable programs include, for instance, a compiled program that can be translated into a machine code format and loaded into a random access portion of the memory 544 and executed by the processor 542, source code that can be expressed in an object code format and loaded into a random access portion of the memory 544 and executed by the processor 542, source code that can be interpreted by another executable program to generate instructions in a random access portion of the memory 544 and executed by the processor 542, or other executable programs or code.

The local interface 546 can be embodied as a data bus with an accompanying address/control bus or other addressing, control, and/or command lines. In part, the local interface 546 can be embodied as, for instance, an on-board diagnostics (OBD) bus, a controller area network (CAN) bus, a local interconnect network (LIN) bus, a media oriented systems transport (MOST) bus, ethernet, or another network interface.

The data store 548 can include data for the computing device 540 such as, for instance, one or more unique identifiers for the computing device 540, digital certificates, encryption keys, session keys and session parameters for communications, and other data for reference and processing. The data store 548 can also store computer-readable instructions for execution by the computing device 540 via the processor 542, including instructions for the additive manufacturing control application 550, the movement mechanism control module 552, the print head control module 554, the conveyor belt control module 556, and the communications stack 558. In some cases, the data store 548 can also store at least one of original toolpaths (e.g., “Geometry Code” or “GCode” instructions for fabricating one or more objects using the additive manufacturing apparatus 100 as described in examples herein) or modified toolpaths (e.g., original toolpaths that have been modified to account for a desired or selected speed of the belt 132 as described herein with reference to FIGS. 6 and 7). In another example, the data store 548 can also store various specification and operation data or information for any or all of the movement mechanism 110, the print head 120, the robotic arm 122, the conveyor belt 130, or the belt 132, among possible other components of the additive manufacturing apparatus 100. For instance, the data store 548 can store at least one of predefined commands for operating such components (e.g., default robot trajectories, default material extrusion flow rates, default conveyor belt speeds) or modified commands (e.g., predefined commands that have been modified based on modified toolpaths to account for a desired or selected speed of the belt 132 as described herein with reference to FIGS. 6 and 7).

The additive manufacturing control application 550 can be embodied as one or more software applications or services executing on the computing device 540. For example, the additive manufacturing control application 550 can be embodied as and can include at least one of the movement mechanism control module 552, the print head control module 554, the conveyor belt control module 556, or another module. The additive manufacturing control application 550 can be executed by the processor 542 to implement (e.g., execute) at least one of the movement mechanism control module 552, the print head control module 554, or the conveyor belt control module 556. Each of the movement mechanism control module 552, the print head control module 554, and the conveyor belt control module 556 can also be respectively embodied as one or more software applications or services executing on the computing device 540. In one example, the additive manufacturing control application 550 can be executed by the processor 542 to fabricate one or more of objects using the movement mechanism control module 552, the print head control module 554, and the conveyor belt control module 556 as described in examples herein. In one example, the additive manufacturing control application 550 can be executed by the processor 542 to implement either or both of the AM method 400 or the computer-implemented additive manufacturing method 600 described herein with reference to FIGS. 4 and 6, respectively.

The movement mechanism control module 552 can be embodied as one or more software applications or services executing on the computing device 540. The movement mechanism control module 552 can be executed by the processor 542 to generate commands for operating the movement mechanism 110, for instance, for moving (e.g., within any of six degrees of freedom) and/or otherwise operating at least one of the print head 120 or the robotic arm 122, among possibly other components of the movement mechanism 110 in some cases. The movement mechanism control module 552 can further provide such commands to at least one of the movement mechanism 110, the print head 120, or the robotic arm 122, and/or such other components in some cases. For example, the movement mechanism control module 552 can use a toolpath or a modified toolpath (e.g., GCode or modified GCode for fabricating an object) to generate commands for operating the movement mechanism 110 (e.g., the print head 120 and the robotic arm 122) as described in examples herein. For instance, the movement mechanism control module 552 can use such a toolpath or modified toolpath to generate commands that when executed by the movement mechanism 110 can cause at least one of the robotic arm 122 or the print head 120 to move along robot trajectories defined in the toolpath or modified toolpath to position the print head 120 at certain locations over the deposition surface 134 for a defined duration at certain times.

The print head control module 554 can be embodied as one or more software applications or services executing on the computing device 540. The print head control module 554 can be executed by the processor 542 to generate commands for operating the print head 120. The print head control module 554 can further provide such commands to at least one of the movement mechanism 110 or the print head 120. For example, the print head control module 554 can use a toolpath or a modified toolpath (e.g., GCode or modified GCode for fabricating an object) to generate commands for operating the print head 120 as described in examples herein. For instance, the print head control module 554 can use such a toolpath or modified toolpath to generate commands that when executed by the print head 120 can cause the print head 120 to extrude a certain depositing material for a defined duration at a certain flow rate at certain times.

The conveyor belt control module 556 can be embodied as one or more software applications or services executing on the computing device 540. The conveyor belt control module 556 can be executed by the processor 542 to generate commands for operating at least one of the conveyor belt 130 or the belt 132, among possibly other components of the conveyor belt 130 in some cases. The conveyor belt control module 556 can further provide such commands to at least one of the conveyor belt 130 or the belt 132, and/or such other components in some cases. For example, the conveyor belt control module 556 can use a toolpath or a modified toolpath (e.g., GCode or modified GCode for fabricating an object) to generate commands for operating the conveyor belt 130 and the belt 132 as described in examples herein. For instance, the conveyor belt control module 556 can use such a toolpath or modified toolpath to generate commands that when executed by the conveyor belt 130 can cause the belt 132 to operate in one or more stationary phases or moving phases (e.g., at a particular speed or speeds) for certain durations at certain times.

The communications stack 558 can include software and hardware layers to implement data communications such as, for instance, Bluetooth®, Bluetooth® Low Energy (BLE), WiFi®, cellular data communications interfaces, dedicated short-range communications (DSRC) interfaces, or a combination thereof. Thus, the communications stack 558 can be relied upon by the computing device 540 to establish DSRC, cellular, Bluetooth®, WiFi®), and other communications channels with the movement mechanism 110, the print head 120, the conveyor belt 130, and the network 150.

The communications stack 558 can include the software and hardware to implement Bluetooth®, BLE, DSRC, and related networking interfaces, which provide for a variety of different network configurations and flexible networking protocols for short-range, low-power wireless communications. The communications stack 558 can also include the software and hardware to implement WiFi® communication, DSRC communication, and cellular communication, which also offers a variety of different network configurations and flexible networking protocols for mid-range, long-range, wireless, and cellular communications. The communications stack 558 can also incorporate the software and hardware to implement other communications interfaces, such as X10®, ZigBee®, Z-Wave®, and others. The communications stack 558 can be configured to communicate various data to and from the movement mechanism 110, the print head 120, and the conveyor belt 130 by way of the network 150. For example, the communications stack 558 can be configured to allow for the computing device 540, the movement mechanism 110, the print head 120, and the conveyor belt 130 to share at least one of toolpath data, commands data, position data, and speed data, among possible other data.

FIG. 6 illustrates a diagram of an example computer-implemented additive manufacturing method 600 according to various aspects and embodiments of the present disclosure. In one example, the computer-implemented additive manufacturing method 600 (or “method 600”) can be implemented by the additive manufacturing apparatus 100 using the movement mechanism 110 (e.g., the print head 120 and the robotic arm 122), the conveyor belt 130 (e.g., the belt 132), and the controller 140, For example, the method 600 can be implemented by the additive manufacturing apparatus 100 using the computing device 540 (e.g., the additive manufacturing control application 550, the movement mechanism control module 552, the print head control module 554, and the conveyor belt control module 556) to control the movement mechanism 110 (e.g., the print head 120 and the robotic arm 122) and the conveyor belt 130. The method 600 can be implemented to fabricate an object or a component thereof such as, for instance, the objects 160, 260, 360, 960, 1060 or the portions 462a, 462b of a layer of depositing material described herein and illustrated in FIGS. 1, 2, 3, 4, 9, and 10. The method 600 can also be implemented to perform the AM method 400 described herein and illustrated in FIG. 4.

At 610, the method 600 includes receiving a desired object geometry of an object to be built using an additive manufacturing apparatus. For instance, the additive manufacturing control application 550 can receive a digital file including the desired object geometry by way of the computing device 540. The digital file can include data that is indicative of and defines various attributes of an object to be built (e.g., any of the objects 160, 260, 360, 960, 1060) such as, for instance, the shape, size, and material type (e.g., indicating which ink to use in fabricating the object), among possibly other attributes.

At 620, the method 600 includes generating a toolpath for fabricating the object based on the digital file received at step 610. To generate the toolpath for fabricating the object, at 622, the method 600 includes chunking the object (or “Chunk Part”). For instance, the additive manufacturing control application 550 can use the digital file to segment the object into sections or chunks that correspond to segments of a deposition surface on which the object will be fabricated. For example, the additive manufacturing control application 550 can use a digital file including data indicative of and defining the geometry, size, and material type of the object 160 to segment the object 160 into chunks C1, C2, C3 corresponding to segments S1, S2, S3 of the deposition surface 134. In some cases, the additive manufacturing control application 550 can segment the object along one or more linear or non-linear slicing plane lines of the object. In other examples, the additive manufacturing control application 550 can segment the object along one or more planar or non-planar surfaces of the object such as, for instance, a flat or curved surface of the object.

At 624, the method 600 includes bias slicing at least one of the object or one or more of the chunks defined at step 622. For instance, the additive manufacturing control application 550 can divide the object or any of the chunks into multiple slicing planes (e.g., linear or non-linear planes) or layers (e.g., planar or non-planar layers). For example, the additive manufacturing control application 550 can use the aforementioned digital file including the geometry and size of the object 160 to divide the object 160 or any of the chunks C1, C2, C3 into multiple slicing planes or layers such as any or all of the layers 262a, 262b, 262c, 262d, 362a, 362b, 362c, 362d described herein and illustrated in FIGS. 2 and 3.

At 626, the method 600 includes deforming an additive manufacturing toolpath defined for fabricating the object. For instance, the additive manufacturing control application 550 can deform (e.g., modify) additive manufacturing geometry code (GCode) instructions for fabricating the object. For example, the additive manufacturing control application 550 can. deform the GCode along axis “X” illustrated in FIGS. 1 to 4 based on a selected conveyor belt speed for the belt 132 of the conveyor belt 130. In various examples, the additive manufacturing control application 550 can deform the GCode to account for depositing multiple layers of depositing material between moving phases of the belt 132, or to account for the various angles of such layers relative to the deposition surface 134, or to form such layers in a non-linear manner such that each is non-planar relative to the deposition surface 134, or to account for constant or varying speed of the belt 132 during material deposition relative to at least one of the movement mechanism 110, the print head 120, or the robotic arm 122, or to account for properties of a material to be used in fabricating the object.

In one example, the additive manufacturing control application 550 can deform an. object toolpath as illustrated by the toolpath deformation 700 depicted in FIG. 7. FIG. 7 illustrates an example toolpath deformation 700 according to various aspects and embodiments of the present disclosure. In one example, the toolpath deformation 700 can be performed by the additive manufacturing control application 550 at step 626 of the method 600 to deform an original object toolpath 710 along an axis to generate a modified object toolpath 720 that accounts for a selected speed of the belt 132 on the conveyor belt 130.

Returning to FIG. 6, at 628, the method 600 includes injecting conveyor commands into the modified GCode created at step 626. For instance, the additive manufacturing control application 550 can inject (e.g., include) instructions in the modified GCode to operate the conveyor belt 130 and the belt 132 in at least one stationary phase or a moving phase for one or more defined durations during which the print head 120 may or may not be extruding a depositing material.

At 630, the method 600 includes converting the modified GCode created at step 626 or step 628 to robot trajectories. For instance, the additive manufacturing control application 550 can convert the modified GCode to robot trajectories that can be implemented by the movement mechanism 110 (e.g., the print head 120 and the robotic arm 122) for one or more defined durations during which the print head 120 may or may not be extruding a depositing material and the belt 132 may or may not be moving. Completion of step 630 yields a toolpath for fabricating the object of this example.

At 640, the method 600 includes providing the toolpath from step 630 to the movement mechanism control module 552, the print head control module 554, and the conveyor belt control module 556 for command generation at 650 of the method 600. At 650. the movement mechanism control module 552 can use the toolpath to generate commands for operating the movement mechanism 110. For instance, the movement mechanism control module 552 can use the toolpath to generate commands that when executed by the movement mechanism 110 can cause the robotic arm 122 and/or the print head 120 to move along robot trajectories defined in the toolpath to position the print head 120 at certain locations over the deposition surface 134 for a defined duration at certain times. At 650, the print head control module 554 can use the toolpath to generate commands for operating the print head 120. For instance, the print head control module 554 can use the toolpath to generate commands that when executed by the print head 120 can cause the print head 120 to extrude a certain depositing material for a defined duration at a certain flow rate at certain times. At 650, the conveyor belt control module 556 can use the toolpath to generate commands for operating the conveyor belt 130 and the belt 132. For instance, the conveyor belt control module 556 can use the toolpath to generate commands that when executed by the conveyor belt 130 can cause the belt 132 to operate in one or more stationary phases or moving phases (e.g., at a particular speed or speeds) for certain durations at certain times.

At 660, the method 600 includes providing the commands generated at step 650 to the movement mechanism 110 (e.g., to operate the robotic arm 122 and the print head 120), the print head 120, and the conveyor belt 130 for additive manufacturing of the object in this example at 670 of the method 600. At 670, the movement mechanism 110 can implement the commands provided by the movement mechanism control module 552 to move the robotic arm 122 and/or the print head 120 along robot trajectories defined in the toolpath to position the print head 120 at certain locations over the deposition surface 134 for a defined duration at certain times. At 670, the print head 120 can implement the commands provided by the print head control module 554 to extrude a certain depositing material for a defined duration at a certain flow rate at certain times, At 670, the conveyor belt 130 can implement the commands provided by the conveyor belt control module 556 to operate the belt 132 in one or more stationary phases or moving phases (e.g., at a particular speed or speeds) for certain durations at certain times.

At 675, the method 600 includes the print head 120 providing speed data to the movement mechanism 110 during additive manufacturing at step 670. For instance, the print head 120 can provide the flow rate at which the print head 120 is extruding depositing material over certain locations of the deposition surface 134 at certain times during additive manufacturing at step 670.

At 680, the method 600 includes the conveyor belt 130 providing speed data to the movement mechanism 110 during additive manufacturing at step 670. For instance, the conveyor belt 130 can provide the constant or varying speed at which the belt 132 is operating (or not) for certain durations at certain times during additive manufacturing at step 670.

At 690, the method 600 includes providing position data to at least one of the movement mechanism control module 552, the print head control module 554, or the conveyor belt control module 556 for revised command generation at step 650 of the method 600. For instance, the movement mechanism 110 can provide position data indicative of a current position of at least one of the print head 120, the robotic arm 122, the belt 132, the deposition surface 134, or the object being fabricated. Additionally, the movement mechanism 110 can also provide the speed data obtained from at least one of the print head 120 or the conveyor belt 130 at step 675 or 680, respectively. Upon receiving such position and/or speed data at 690, any or all of the movement mechanism control module 552, the print head control module 554, and the conveyor belt control module 556 can use such data to generate updated commands for controlling their corresponding components. For instance, at 650, the movement mechanism control module 552 can use the position and/or speed data to generate updated commands for controlling the movement mechanism 110 (e.g., updated commands for moving the robotic arm 122 and the print head 120). In this example, the print head control module 554 can use the position and/or speed data to generate updated commands for controlling the print head 120 (e.g., updated commands for extruding depositing material). In this example, the conveyor belt control module 556 can generate updated commands for controlling the conveyor belt 130 (e.g., updated commands for operating the belt 132 in one or more stationary or moving phases).

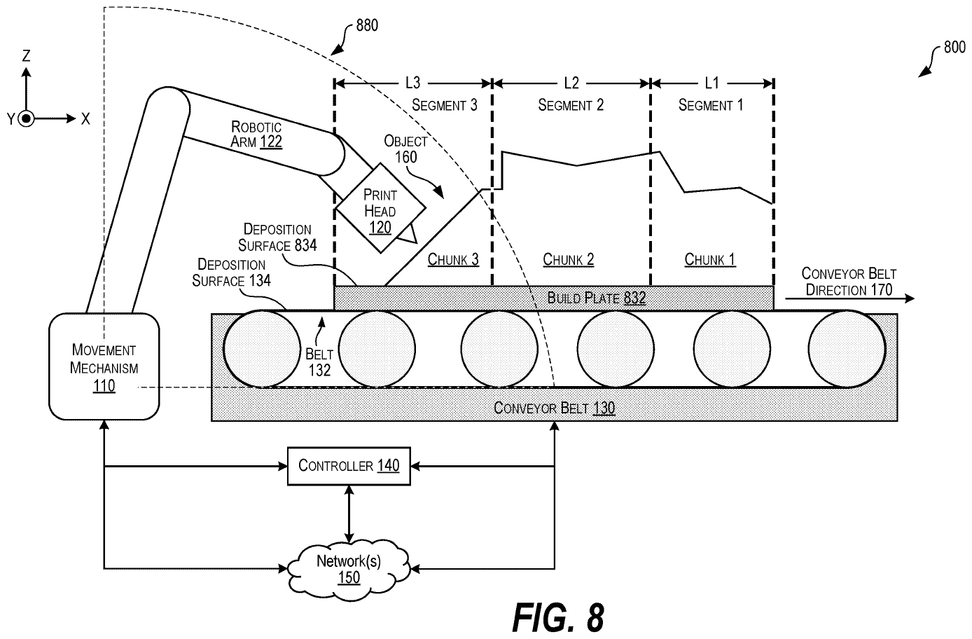

FIG. 8 illustrates a schematic of another example additive manufacturing apparatus 800 implemented to fabricate the object 160 according to various aspects and embodiments of the present disclosure. The additive manufacturing apparatus 800 is an example alternative embodiment of the additive manufacturing apparatus 100 described herein and illustrated in FIGS. 1, 2, 3, and 4. The additive manufacturing apparatus 800 includes the same or similar components, structure, attributes, and functionality as that of the additive manufacturing apparatus 100. A difference between the additive manufacturing apparatus 800 and the additive manufacturing apparatus 100 is that the additive manufacturing apparatus 800 further includes a build plate 832 having a deposition surface 834 upon which a depositing material can be deposited by the print head 120 to build the object 160.

In some examples, the build plate 832 can be removably coupled to at least one of the conveyor belt 130 or the belt 132. In other examples, the build plate 832 can be permanently coupled (e.g., as an integrated or integral component) to at least one of the conveyor belt 130 or the belt 132. To fabricate the object 160 on the build plate 832 as illustrated in FIG. 8, the additive manufacturing apparatus 800 can be implemented in the same or similar manner as the additive manufacturing apparatus 100 to perform the same or similar operations as those described herein with reference to fabricating any of the objects 160, 260, 360, illustrated in FIGS. 1, 2, and 3, respectively. For instance, the controller 140 can control the movement mechanism 110 (e.g., the print head 120 and the robotic arm 122) to respectively deposit multiple layers of a depositing material across segments S1, S2, S3 of the deposition surface 834 of the build plate 832 while the belt 132 is in at least one stationary phase or a moving phase. In some examples, the controller 140 can control the movement mechanism 110 and the print head 120 such that the orientation (e.g., an angle relative to the plane of the build plate 832) of a slicing plane in one segment is different from the orientation of a slicing plane in a different segment.

The robotic arm 122 of the movement mechanism 110 allows positioning of the print head 120 anywhere along the deposition surface 134 and the deposition surface 834 that is within the reach of the robotic arm 122 when the conveyor belt 130 is in a stationary or moving phase. For example, as depicted in FIG. 8, the robotic arm 122 of the movement mechanism 110 allows positioning of the print head 120 anywhere along the deposition surface 134 and the deposition surface 834 that is within a build envelope 880 of the movement mechanism 110 (e.g., within reach of the robotic arm 122) when the conveyor belt 130 is in a stationary or moving phase. In some examples, the build envelope 880 can be larger or smaller than depicted in FIG. 8.

In some examples, the controller 140 can control the conveyor belt 130 in at least one moving phase to move the conveyor belt 130 by a distance that is equal to a length of any of the segment S1, S2, S3 of the deposition surface 834. In the example shown, the build plate 832 is segmented into a segments S1, S2, and S3 having lengths L1, L2, and L3, respectively. The segments S1, S2, S3 can be of equal lengths or of unequal lengths. The length can be measured along a dimension of the conveyor belt 130 along the direction of motion of the belt 132 (e.g., along an axis “X” depicted in FIG. 8). During the building process, the controller 140 can control the conveyor belt 130 in at least one moving phase, to move the belt 132 by a distance of L1, L2, or L3 to allow the building of the object 160 within each segment. The controller 140 also can control the movement mechanism 110 and the print head 120 during at least one stationary phase of the conveyor belt 130 to deposit the depositing material over one of the segments S1, S2, S3. For example, the controller 140 can control the movement mechanism 110 and the print head 120 to deposit the depositing material over segment S1 to build chunk C1. While building chunk C1 in segment S1, the controller 140 can control the movement mechanism 110 and the print head 120 to deposit the depositing material in at least one layer or slicing plane (e.g., two or more), which can each be planar or non-planar. In some cases, the controller 140 can control the movement mechanism 110 and the print head 120 to deposit the depositing material over a different segment, for example, segment S3. The extent to which the controller 140 can deposit the depositing material during a stationary phase of the conveyor belt 130 can be limited by the reach of the movement mechanism 110. However, the controller 140 can move the conveyor belt 130 forward or backward to bring the desired segment within the reach of the movement mechanism 110.

In some embodiments, the segments S1, S2, S3 of the build plate 832 can be separable. For instance, the build plate 832 can be embodied such that a first segment (e.g., segment S1) can be separated from an adjacent second segment (e.g., segment S2) when the first segment reaches the end of the belt 132. This allows the additive manufacturing apparatus 800 to build different separable segments. In one example, the build plate 832 can be embodied as or formed on a build sheet that is separate from the belt 132 and can be lifted off of the belt 132 when the build sheet reaches the end of the belt 132.

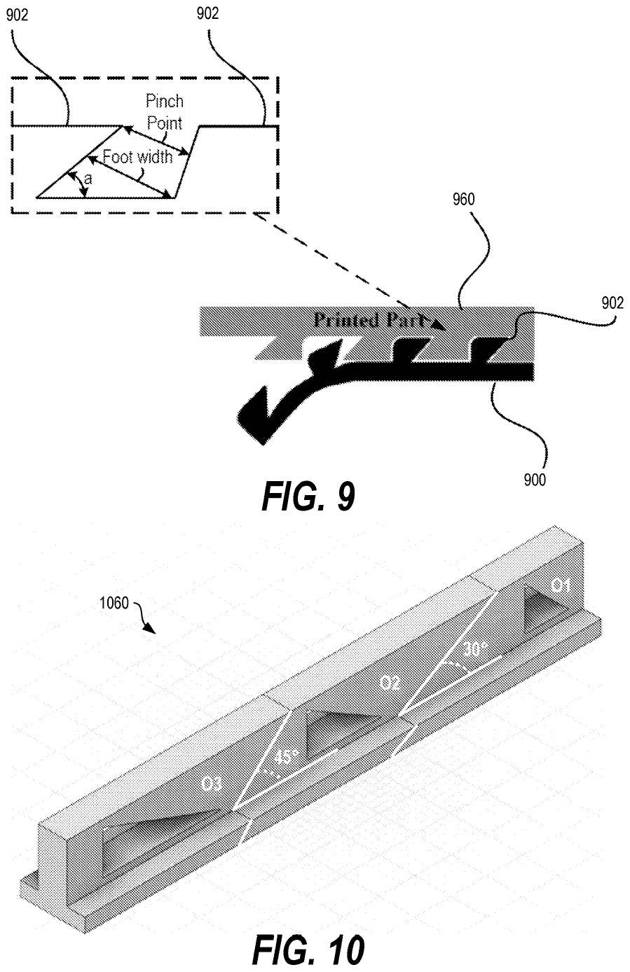

FIG. 9 illustrates a schematic of an example build plate 900 according to various aspects and embodiments of the present disclosure. The build plate 900 is an example alternative embodiment of the build plate 832 described herein and illustrated in FIG. 8. The build plate 900 includes the same or similar components, structure, attributes, and functionality as that of the build plate 832. A difference between the build plate 900 and the build plate 832 is that the build plate 900 further includes one or more cleats 902 as illustrated in FIG. 9. The cleats 902 can increase the adhesion between an object 960 being built and an underlying build surface (e.g., the deposition surface 134 of the belt 132). When the initial layers of the object 960 being built are deposited over the build plate 900, the cleats 902 can improve the mechanical bond between the object 960 and the build plate 900. This can alleviate the problem of the object 960 slipping on an underlying build surface (e.g., the deposition surface 134), which can cause inaccurate deposition of the object layers.

FIG. 9 also shows an expanded view (inset view) of a gap between two cleats 902. Each cleat 902 can have a profile angle “a” that it makes with the surface between the cleat and an adjacent cleat. The profile angle “a” can be selected such that the width of the pinch point (e.g., measured as the smallest distance between a tip of the cleat and the neighboring cleat surface) is less than the foot width (e.g., measured as the distance between the bottom of the immediately adjacent cleat and the surface of the cleat in the direction parallel to the line measuring the pinch point). The build plate 900 including the cleats 902 can be adapted to operate on the deposition surface 134 of the belt 132 on the conveyor belt 130 of the additive manufacturing apparatus 100. In one example, the build plate 900 can be wrapped around the belt 132 or the conveyor belt 130 to cover a portion of or the entirety of the belt 132 or the conveyor belt 130. In some cases, the thickness of the build plate 900 can be selected to allow for the build plate 900 to easily bend around rollers of the conveyor belt 130. In some examples, the material used to build the build plate 900 can be selected to be flexible to allow for the build plate 900 to effectively bend around rollers of the conveyor belt 130. When an object, which is adhered to the cleats 902 of the build plate 900 reaches the edge of the conveyor belt 130, the build plate 900 can bend, resulting in adjacent cleats 902 holding the object 960 to naturally separate and release the object 960 from the build plate 900.

FIG. 10 illustrates an example segmented object 1000 built with differently angled slicing planes according to various aspects and embodiments of the present disclosure. The segmented object 1000 can be fabricated using the additive manufacturing apparatus 100 or the additive manufacturing apparatus 800 to perform the same or similar operations as those described herein with reference to fabricating any of the objects 160, 260, 360, illustrated in FIGS. 1, 2, 3, and 8. For instance, the controller 140 can control the movement mechanism 110 (e.g., the print head 120 and the robotic arm 122) to respectively deposit multiple layers of a depositing material across segments of the deposition surface 134 of the belt 132 while the belt 132 is in at least one stationary phase or a moving phase. In some examples, the controller 140 can control the movement mechanism 110 and the print head 120 such that the orientation (e.g., an angle relative to a plane of the deposition surface 134) of a slicing plane in one segment is different from the orientation of a slicing plane in a different segment. For example, as illustrated in FIG. 10, the additive manufacturing apparatus 100 can fabricate the segmented object 1000 such that it includes a first object “O1,” a second object “O2,” and a third object “O3” formed in different segments of the deposition surface 134. In this example, the additive manufacturing apparatus 100 can fabricate the segmented object 1000 such that a slicing angle of the second object O2 is 30 degrees (30°) in relation to the deposition surface 134, while a slicing angle of the third object O3 is 45 degrees (45°) in relation to the deposition surface 134.

In some instances, it can be advantageous to maintain a build surface (e.g., the deposition surface 134 of the belt 132, the deposition surface 834 of the build plate 832, or the cleat surfaces of the cleats 902 of the build plate 900) at a certain temperature to ensure uniform drying and/or cooling of a depositing material over a length of the conveyor belt 130. This can improve the accuracy of the shape and the mechanical strength of objects being built, especially when the objects have a substantially long length. Although not illustrated in the figures, in some embodiments, at least one of the conveyor belt 130, the belt 132, the deposition surface 134 of the belt 132, the build plate 832, the deposition surface 834 of the build plate 832, the build plate 900, or a cleat surface of the cleats 902 of the build plate 900 can have a metallic or partially metallic build surface upon which depositing material can be deposited. In these embodiments, at least one of the conveyor belt 130, the belt 132, the build plate 832, or the build plate 900 can include a heating element positioned below at least a portion of its build surface. The controller 140 can control the temperature of such a build surface by controlling the heating element.

Referring now to FIG. 5, an executable program can be stored in any portion or component of the memory 544 including, for example, a random access memory (RAM), read-only memory (ROM), magnetic or other hard disk drive, solid-state, semiconductor, universal serial bus (USB) flash drive, memory card, optical disc (e.g., compact disc (CD) or digital versatile disc (DVD)), floppy disk, magnetic tape, or other types of memory devices.

In various embodiments, the memory 544 can include both volatile and nonvolatile memory and data storage components. Volatile components are those that do not retain data values upon loss of power. Nonvolatile components are those that retain data upon a loss of power. Thus, the memory 544 can include, for example, a RAM, ROM, magnetic or other hard disk drive, solid-state, semiconductor, or similar drive, USB flash drive, memory card accessed via a memory card reader, floppy disk accessed via an associated floppy disk drive, optical disc accessed via an optical disc drive, magnetic tape accessed via an appropriate tape drive, and/or other memory component, or any combination thereof. In addition, the RAM can include, for example, a static random-access memory (SRAM), dynamic random-access memory (DRAM), or magnetic random-access memory (MRAM), and/or other similar memory device. The ROM can include, for example, a programmable read-only memory (PROM), erasable programmable read-only memory (EPROM), electrically erasable programmable read-only memory (EEPROM), or other similar memory device.

As discussed above, the additive manufacturing control application 550, the movement mechanism control module 552, the print head control module 554, the conveyor belt control module 556, and the communications stack 558 can each be embodied, at least in part, by software or executable-code components for execution by general purpose hardware. Alternatively, the same can be embodied in dedicated hardware or a combination of software, general, specific, and/or dedicated purpose hardware. If embodied in such hardware, each can be implemented as a circuit or state machine, for example, that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components.

Referring now to FIGS. 4 and 6, the flowchart or process diagram shown in each of FIGS. 4 and 6 is representative of certain processes, functionality, and operations of the embodiments discussed herein. Each block can represent one or a combination of steps or executions in a process. Alternatively, or additionally, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as the processor 542. The machine code can be converted from the source code. Further, each block can represent, or be connected with, a circuit or a number of interconnected circuits to implement a certain logical function or process step.

Although the flowchart or process diagram shown in each of FIGS. 4 and 6 illustrates a specific order, it is understood that the order can differ from that which is depicted. For example, an order of execution of two or more blocks can be scrambled relative to the order shown. Also, two or more blocks shown in succession can be executed concurrently or with partial concurrence. Further, in some embodiments, one or more of the blocks can be skipped or omitted. In addition, any number of counters, state variables, warning semaphores, or messages might be added to the logical flow described herein, for purposes of enhanced utility, accounting, performance measurement, or providing troubleshooting aids. Such variations, as understood for implementing the process consistent with the concepts described herein, are within the scope of the embodiments.

Also, any logic or application described herein, including the additive manufacturing control application 550, the movement mechanism control module 552, the print head control module 554, the conveyor belt control module 556, and the communications stack 558 can be embodied, at least in part, by software or executable-code components, can be embodied or stored in any tangible or non-transitory computer-readable medium or device for execution by an instruction execution system such as a general-purpose processor. In this sense, the logic can be embodied as, for example, software or executable-code components that can be fetched from the computer-readable medium and executed by the instruction execution system. Thus, the instruction execution system can be directed by execution of the instructions to perform certain processes such as those illustrated in each of FIGS. 4 and 6. In the context of the present disclosure, a non-transitory computer-readable medium can be any tangible medium that can contain, store, or maintain any logic, application, software, or executable-code component described herein for use by or in connection with an instruction execution system.

The computer-readable medium can include any physical media such as, for example, magnetic, optical, or semiconductor media. More specific examples of suitable computer-readable media include, but are not limited to, magnetic tapes, magnetic floppy diskettes, magnetic hard drives, memory cards, solid-state drives, USB flash drives, or optical discs. Also, the computer-readable medium can include a RAM including, for example, an SRAM, DRAM, or MRAM. In addition, the computer-readable medium can include a ROM, a PROM, an EPROM, an EEPROM, or other similar memory device.

Disjunctive language, such as the phrase “at least one of X, Y, or Z,” unless specifically stated otherwise, is to be understood with the context as used in general to present that an item, term, or the like, can be either X, Y, or Z, or any combination thereof (e.g., X, Y, and/or Z). Thus, such disjunctive language is not generally intended to, and should not, imply that certain embodiments require at least one of X, at least one of Y, or at least one of Z to be each present. As referenced herein in the context of quantity, the terms “a” or “an” are intended to mean “at least one” and are not intended to imply “one and only one.”

As referred to herein, the terms “include,” “includes,” and “including” are intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify the location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. An additive manufacturing apparatus, comprising:
a movement mechanism comprising a print head configured to extrude a depositing material;
a conveyor belt comprising a deposition surface to support the depositing material from the print head; and
a controller coupled to the movement mechanism, the print head, and the conveyor belt, the controller being configured to:
control the conveyor belt to operate in a moving phase when the conveyor belt moves; and
control the movement mechanism and the print head to extrude a layer of the depositing material over the deposition surface based on a variable deposition plane when the conveyor belt is in the moving phase.

2. The additive manufacturing apparatus of claim 1, wherein the controller is further configured to:
control the movement mechanism and the print head to extrude the layer of the depositing material over the deposition surface based on a curved deposition surface when the conveyor belt is in the moving phase.

3. The additive manufacturing apparatus of claim 1, wherein the controller is further configured to:
control the movement mechanism and the print head to deposit the layer of the depositing material in a first deposition plane when the conveyor belt is in the moving phase; and
control the movement mechanism and the print head to deposit a second layer of the depositing material in a second deposition plane when the conveyor belt is in the moving phase, the second plane being different from the first plane.

4. The additive manufacturing apparatus of claim 3, wherein the first deposition plane has a first angle relative to the deposition surface and the second deposition plane has a second angle relative to the deposition surface, the second angle being different from the first angle.

5. The additive manufacturing apparatus of claim 1, wherein the controller is further configured to:
control the movement mechanism and the print head to deposit the depositing material over a first segment of the deposition surface when the conveyor belt is in the moving phase; and
control the movement mechanism and the print head to deposit the depositing material over a second segment of the deposition surface when the conveyor belt is in the moving phase, the second segment being different from the first segment.

6. The additive manufacturing apparatus of claim 5, wherein the controller is further configured to:
control the movement mechanism and the print head to deposit the depositing material over the first segment in a first deposition plane when the conveyor belt is in the moving phase; and
control the movement mechanism and the print head to deposit the depositing material over the second segment in a second deposition plane when the conveyor belt is in the moving phase, the second plane being different from the first plane.

7. The additive manufacturing apparatus of claim 6, wherein the first deposition plane has a first angle relative to the deposition surface and the second deposition plane has a second angle relative to the deposition surface, the second angle being different from the first angle.

8. The additive manufacturing apparatus of claim I, wherein the movement mechanism comprises a robotic arm.

9. An additive manufacturing method of fabricating an object, the method comprising:
operating, by a controller, a conveyor belt in a moving phase when the conveyor belt moves, the conveyor belt comprising a deposition surface to accept a depositing material; and
operating, by the controller, a movement mechanism and a print head coupled to the movement mechanism to extrude a layer of the depositing material over the deposition surface based on a variable deposition plane when the conveyor belt is in the moving phase.

10. The method of claim 9, further comprising:
operating, by the controller, the movement mechanism and the print head to extrude the layer of the depositing material over the deposition surface based on a curved deposition surface when the conveyor belt is in the moving phase.

11. An additive manufacturing apparatus, comprising:
a movement mechanism having at least four degrees of freedom;
a print head coupled to the movement mechanism and configured to extrude a depositing material;
a conveyor belt comprising a deposition surface to accept the depositing material from the print head; and
a controller coupled to the movement mechanism, the print head, and the conveyor belt, the controller being configured to:
control the conveyor belt to operate between stationary phases when the conveyor belt is stationary and moving phases when the conveyor belt moves; and
control the movement mechanism and the print head to extrude two or more layers of the depositing material over the deposition surface when the conveyor belt is in one of the stationary phases.

12. The additive manufacturing apparatus of claim 11, wherein the controller is further configured to:
control the movement mechanism and the print head to extrude a layer of the two or more layers of the depositing material over the deposition surface based on a curved deposition surface.

13. The additive manufacturing apparatus of claim 11, wherein the controller is further configured to:
control the movement mechanism and the print head to deposit a first layer of the two or more layers of the depositing material in a first deposition plane when the conveyor belt is in a stationary phase of the stationary phases; and
control the movement mechanism and the print head to deposit a second layer of the two or more layers of the depositing material in a second deposition plane when the conveyor belt is in the stationary phase, the second plane being different from the first plane.

14. The additive manufacturing apparatus of claim 13, wherein the first deposition plane has a first angle relative to the deposition surface and the second deposition plane has a second angle relative to the deposition surface, the second angle being different from the first angle.

15. The additive manufacturing apparatus of claim 11, wherein the controller is further configured to:
control the conveyor belt to move the deposition surface in a first direction and a second direction that is opposite to the first direction.

16. The additive manufacturing apparatus of claim 11, wherein the controller is further configured to:
control the conveyor belt during a moving phase of the moving phases to move the conveyor belt by a distance that is equal to a length of a segment of the deposition surface; and
control the movement mechanism and the print head to deposit the two or more layers of the depositing material over the segment of the deposition surface when the conveyor belt is in a stationary phase of the stationary phases.

17. The additive manufacturing apparatus of claim 11, wherein the controller is further configured to:
control the movement mechanism and the print head to deposit the depositing material over a first segment of the deposition surface when the conveyor belt is in a stationary phase of the stationary phases; and
control the movement mechanism and the print head to deposit the depositing material over a second segment of the deposition surface when the conveyor belt is in the stationary phase, the second segment being different from the first segment.

18. The additive manufacturing apparatus of claim 17, wherein the controller is further configured to:
control the movement mechanism and the print head to deposit the depositing material over the first segment in a first deposition plane when the conveyor belt is in the stationary phase; and
control the movement mechanism and the print head to deposit the depositing material over the second segment in a second deposition plane when the conveyor belt is in the stationary phase, the second plane being different from the first plane.

19. The additive manufacturing apparatus of claim 18, wherein the first deposition plane has a first angle relative to the deposition surface and the second deposition plane has a second angle relative to the deposition surface, the second angle being different from the first angle.

20. The additive manufacturing apparatus of claim 11, wherein the movement mechanism further comprises a robotic arm.
